(19) United States
(12) Patent Application Publication
(10) Pub. No.: US 2006/0032722 A1
(43) Pub. Date: Feb. 16, 2006

(54) Retrofit hydraulic power take-off clutch

(76) Inventors: Joseph W. Guinter, Bay Village, OH (US); Robert E. Herchick, Copley, OH (US); David C. Heidenreich, Akron, OH (US)

Correspondence Address: Ray L. Weber;Renner, Kenner, Greive, Bobak, Taylor & Weber, First National Tower, Fourth Floor, Akron, OH, 44308-1456, US

(21) Appl. No.: 10/917,336

(22) Filed: Aug. 13, 2004

(51) Int. Cl. F16D 25/0638

(52) U.S. Cl. 192/85 AA; 192/70.13

(57) ABSTRACT

A hydraulic dry power take-off clutch is adapted to be retrofit for prior manually actuated dry over-center power take-offs in compliance with certain SAE specifications. Both the resultant clutch and a retrofit kit for effecting the same are presented. According to the invention, an input hub is securedly received upon a shaft with an end plate secured to the input hub. A drive flange is adapted for securement to a flywheel or power source. A hydraulically actuated clutch disk assembly is received by the input hub and is in interconnection with the dry flange. Finally, a rotary union is received upon an end of the input hub opposite that of the clutch disk assembly, the rotary union providing a conduit for passing pressurized hydraulic fluid to the clutch disk assembly. The entire structure is adapted to be received within the same bell housing, and to employ the same drive ring as the prior art dry over-center power take-off units.

### TECHNICAL FIELD

The invention herein resides in the art of power transmission devices and, more particularly, to clutch systems interposed between a power source and load to selectively transfer the power from the source to the load. More particularly, the invention relates to a hydraulically actuated power take-off clutch system, and more specifically, to such a hydraulic clutch system adapted for replacement of a manually actuated over-center clutch within the housing and envelope of the manually actuated clutch.

### BACKGROUND ART

Dry over-center power take-off clutches are in common use from the largest engine driven industrial type employed with shredders and grinders, to simpler smaller machines of all types and natures. Such PTO's have been fraught with problems incident to the utilization of pilot bearings, necessary adjustments, and operator abuse.

A multitude of such over-center power take-off clutches continue in use with the inherent problems just described. Many such clutches comprise commercial embodiments of the clutch set forth in prior U.S. Pat. No. 5,400,862. A large number of those are maintained in housings conforming to SAE J621d, defining the envelope in which the clutch operating mechanism is received. Many such clutches further conform to SAE J620 as to the flywheel ring connector, and to SAE J617c as to the flywheel housing both pattern.

There is a need in the art for a dry hydraulic power take-off clutch that can be readily retrofitted into the envelope of the former mechanical over-center dry clutches within housings having dimensions that conform to SAE J621d, and adapted to mate with a flywheel and flywheel housing conforming to SAE J620 and SAE J617c, respectively.

### SUMMARY OF INVENTION

In light of the foregoing, it is the first aspect of the invention to provide a hydraulic dry power take-off clutch PTO which can be readily retrofitted or substituted for corresponding mechanically actuated dry over-center power take-off clutch.

Another aspect of the invention is the provision of a retrofitted hydraulic power take-off clutch that comprises a rotary union in operative engagement with a clutch disk assembly, the rotary union providing means for transferring pressurized hydraulic fluid from an external source to the clutch disk assembly.

Another aspect of the invention is the provision of a retrofit hydraulic power take-off clutch that eliminates the need for frequent adjustments.

Still a further aspect of the invention is the provision of a retrofit hydraulic power take-off clutch that is less susceptible to operator abuse than the prior dry over-center power take-off clutches.

Yet a further aspect of the invention is the provision of a retrofit hydraulic power take-off clutch that can be configured in various sizes and arrangements to fit a large variety of envelopes of prior mechanical clutches.

The foregoing and other aspects of the invention which will become apparent as the detailed description proceeds are achieved by a kit for converting a manually actuated dry over-center power take-off clutch to a hydraulically actuated one, comprising: an input hub securedly received upon a shaft; an end plate secured to said input hub; a drive flange adapted for securement to a flywheel of a power source; a hydraulically actuated clutch disk assembly received upon a first end of said input hub and in interconnection with the drive flange; and a rotary union received upon an opposite second end of said input hub.

Additional aspects of the invention are achieved by a hydraulic power take-off clutch, comprising: a housing conforming to the envelope of a housing configured according to SAE J621d, said envelope defining an envelope, said envelope receiving: an input hub securedly received upon a shaft; an end plate secured to said input hub; a drive flange adapted for securement to a flywheel of a power source; a hydraulically actuated clutch disk assembly received upon a first end of said input hub and in interconnection with said drive flange; and a rotary union received upon an opposite second end of said input hub.

### BRIEF DESCRIPTION OF DRAWINGS

For a complete understanding of the objects, techniques and structure of the invention, reference should be made to the following detailed description and accompanying drawings wherein:

FIG. 1 is a cross sectional view of a prior art dry over-center power take-off clutch assembly;

FIG. 2 is a cross sectional view of a hydraulic power take-off clutch adapted to be retrofitted for that of FIG. 1, within the same envelope and housing of FIG. 1;

FIG. 3 is a cross sectional view of the clutch of FIG. 2, taken along the line 3-3;

FIG. 4 is a partial cross sectional view of the rotary union structure incorporated with the clutch of FIG. 2;

FIG. 5 is a partial cross sectional view of the hydraulic fluid input to the rotary union of the invention;

FIG. 6 is a partial cross sectional view of the rotary union employed in the invention, showing the interconnection with the hydraulic drain or return; and

FIG. 7 is a perspective view of the bell housing of the prior art clutch of FIG. 1, modified to receive the hydraulic clutch of FIGS. 2-6.

### BEST MODE FOR CARRYING OUT THE INVENTION

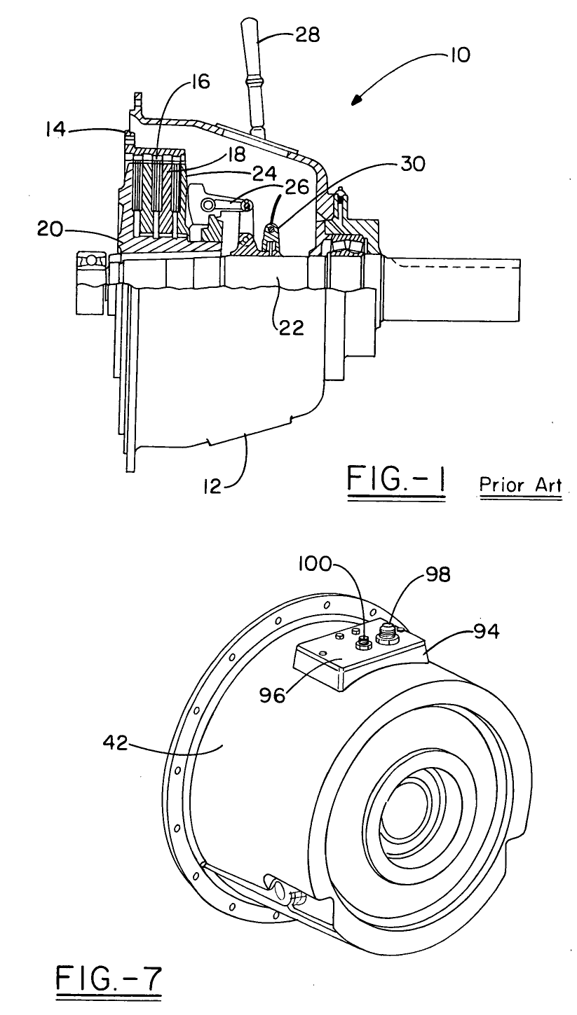

Referring now to the drawings and more particularly FIG. 1, it can be seen that a manually actuated power take-off device with an over-center clutch made in accordance with the prior art is designated generally by the numeral 10. The clutch 10 is a commercial embodiment of the clutch of prior U.S. Pat. No. 5,400,862, and corresponds to SAE J621d standard as to housing size, SAE J620 as to mounting bolt pattern, and SAE J617c as to drive flange configuration. The embodiment shown is general and adaptive to the power output that may be employed, whether skilled in the art will readily appreciate that the concept of the invention extends to coaxial drive shafts and other power outputs.

The clutch assembly 10 includes a bell housing 12 for maintaining the clutch mechanism therein. The bell housing 12 is adapted to be mounted to a power source such as an engine or the like and, in that regard, is provided with standard housing dimensions and mounting bolt spacings corresponding to SAE J621d and SAE J617c.

The clutch 10 includes a drive flange or ring 14 adapted to be mounted upon a flywheel or other power output means of an appropriate power source. Again, the drive flange or ring conforms to a particular SAE standard, such as SAE J620.

Mounted within the bell housing 12 are friction plates or disks 16 and separator plates or disks 18. In the embodiment shown, the friction disks 16 are splined to the drive flange or ring 14, while the separator disks 18 are keyed to the output hub 20. The output hub 20 is keyed to the output shaft 22.

A pressure plate 24 is maintained in juxtaposition to the stack of interleaved disks 16, 18. An over-center actuator 26 is manually controlled by a lever arm 28 to urge the pressure plate 24 into the stack of interleaved disks 16, 18 to cause frictional engagement therebetween and transfer rotational power or torque from the drive flange or ring 14 to the output hub 20 and output shaft 22. A throw out bearing and related mechanism 30 is provided with the mechanical clutch 10 in standard fashion.

Clutch 10, just described, is fraught with problems discussed above regarding pilot bearings, adjustments, and operator abuse. The elimination of such problems is readily achieved by the substitution of a hydraulically actuated power take-off clutch within the same envelope as that receiving the assembly 16-32 as just described.

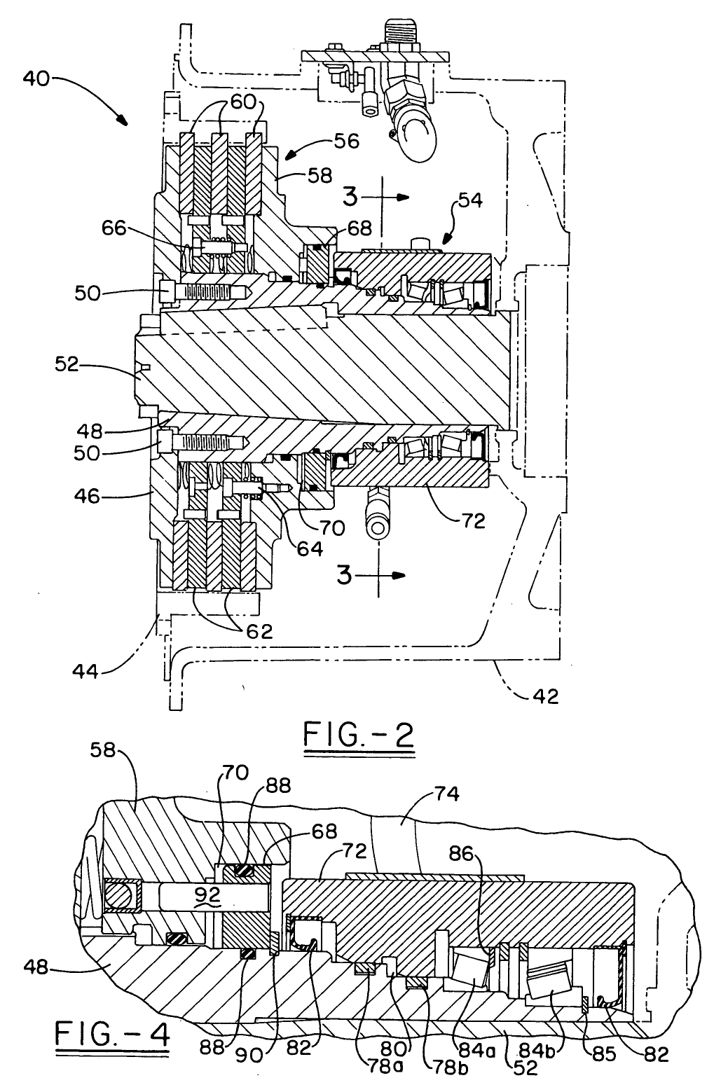

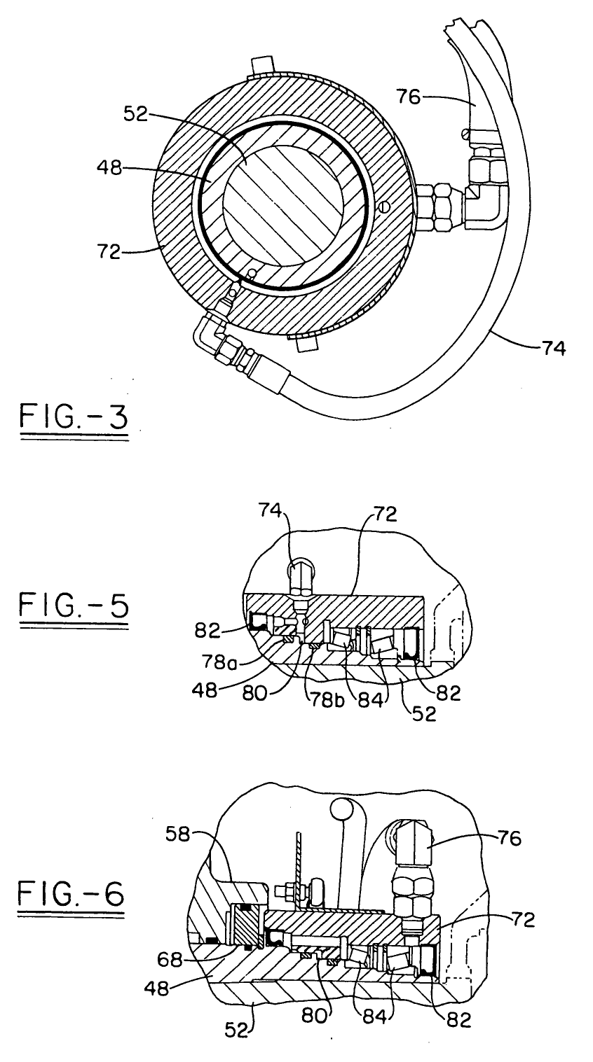

With reference now to FIGS. 2 and 3, a dry hydraulic power take-off clutch made in accordance with the invention can be seen as designated generally by the numeral 40. The clutch conforms to and is received within the bell housing 12 of FIG. 1, consistent with SAE J621d standard housing dimensions and mounting arrangement. Accordingly, the dry-hydraulic clutch 40 is fully interchangeable with the manually actuated clutch 10 of FIG. 1. A drive flange or ring 44, substantially identical to the drive ring or flange 14 is provided for mounting to an end plate 46 which is bolted to an input hub 48 by means of appropriate bolts or other fasteners 50. An input shaft 52 is provided in keyed engagement with the input hub 48 received thereupon and thereabout. Received upon the input shaft 52 are two main components of the dry hydraulic power take-off clutch 40—a rotary union 54 and a clutch disk assembly 56.

The clutch disk assembly 56 includes a piston 58 operative to axially engage friction disks 60 and separator disks 62, the former being splined to the drive flange or ring 44, and the latter keyed to the input hub 48. While the assembly is shown with three friction disks 60 and two separator disks 62, various sizes and diameters of disks 60, 62 may be employed, dependent upon the desired output inertia or torque and/or and the envelope to be filled.

A spring biased shoulder bolt 64 urges a first separator disk 62 from the piston 58. A second spring biased shoulder bolt 66 urges a second separator disk 62 from the first one. Accordingly, a desired and necessary built-in clearance is maintained between the friction and separator disks at times of disengagement. This also precludes the likelihood of inadvertent engagement when the assembly 40 is set on a incline or the like.

A back plate 68 is maintained upon the input hub 48 with an annular space between the back plate 68 and piston 58 defining an annular piston head cavity 70 for the pressure head to be urged against the piston 58 as provided through the rotary union 54.

With further reference to FIGS. 2 and 4, it can be seen that the rotary union 54 includes a collar 72 which is stationary and fixed with the housing 42. An input hydraulic line 74 and a drain or return hydraulic line 76 are provided in association with the collar 72, as shown in FIG. 3. A pair of gland rings 78a, 78b are interposed between the collar 72 and input hub 48 and positioned on either side of an annular cavity 80 adapted for receiving a hydraulic fluid input from the hydraulic line 74. A pair of seals 82 is positioned with one at each end of opposite ends of the collar 72 and interposed between the collar 72 and the input hub 48. A pair of antifriction bearings 84a, 84b is further interposed between the collar 72 and input hub 48, the bearings 84a, 84b being appropriately loaded by wave springs 86.

In the preferred embodiment of the invention, the inboard gland ring 78a is of a larger diameter than the outboard gland ring 78b to provide a hydraulic piston effect on the rotary union collar 72. This tends to load the outboard bearing 84b against the keeper or stop 85 for stabilization against the inherent vibration characteristic of many machines.

As further shown in FIG. 4, a pair of seals 88 is employed, with one interposed between the piston 58 and back plate 68, and the other between the back plate 68 and the input hub 48 to allow for axial movement between the piston 58 and back plate 68.

A keeper ring 90 is received by the input hub 48 to fixedly restrain the back plate 68 thereupon to preclude movement thereof when pressurized hydraulic fluid is introduced into the piston head cavity 70.

As shown in FIG. 4, a dowel 92 passes between the back plate 68 and piston 58 to maintain the two in proper alignment and to prevent canting, skewing and the like.

As shown in FIG. 5, the input hydraulic line 74 is introduced into the annular cavity 80 between the gland rings 78 and away from the antifriction bearings 84a, 84b which necessarily receives some lubrication from hydraulic fluid passing by the gland rings 78. As shown in FIG. 6, a drain line 76 is positioned adjacent an outermost seal 82 and between a gland ring 84 and the seal 82 to receive and return hydraulic fluid passing to the antifriction bearings 84.

With reference to FIG. 7, it can be seen that an access box 94, previously employed in the housing 12 of the manual clutch assembly 10, is provided with a cover plate 96 having a bulk inlet connector 98 for hydraulic fluid input and a bulk outlet connector 100 for the draining of hydraulic fluid.

It should now be readily appreciated that an SAE standard bell housing 12 and drive ring or flange 14 of previously known mechanical dry over-center take-off clutch assemblies may be readily retrofitted by substituting the over-center actuator and associated clutch of the prior art with a hydraulically actuated clutch assembly within the same envelope and adapted for interconnection with an SAE standard flywheel and flywheel housing. By implementing a rotary union and hydraulic clutch assembly upon a single shaft, and by providing a hydraulic fluid conduit within the input hub 48 between the annular input cavity 80 and annular piston head cavity 70, where prior art over-center manual clutches were previously employed, such substitution eliminates the deficiencies of the prior art with respect to adjustments, pilot bearings, and operator abuse. Moreover, the input hub and shaft, with associated rotary union conduits, may be integrally formed, reducing cost and increasing integrity.

Thus it can be seen that the objects of the invention have been satisfied by the structure presented above. While in accordance with the patent statutes only the best mode and preferred embodiment of the invention has been presented and described in detail, it will be appreciated that the invention is not limited thereto or thereby. Accordingly, for an appreciation of the true scope and breadth of the invention reference should be made to the following claims.

What is claimed is:

1. A kit for converting a manually actuated dry over-center power take-off clutch to a hydraulically actuated one, comprising:
an input hub securedly received upon a shaft;
an end plate secured to said input hub;
a drive flange adapted for securement to a flywheel of a power source;
a hydraulically actuated clutch disk assembly received upon a first end of said input hub and in interconnection with said drive flange; and
a rotary union received upon an opposite second end of said input hub.

2. The kit according to claim 1, wherein said hydraulically actuated clutch disk assembly comprises multiple disks operatively connected to said drive flange and multiple separator disks, interleaved with said friction disks, operatively connected to said input hub.

3. The kit according to claim 2, wherein said hydraulicly actuated clutch disk assembly further comprises a piston axially movably received upon said input hub.

4. The kit according to claim 3, wherein the kit is configured as to be received within an internal envelope of a housing.

5. The kit according to claim 4, wherein said rotary union comprises a collar received upon said input hub.

6. The kit according to claim 5, wherein said rotary union further comprises first and second gland rings interposed between said collar and said input hub and defining an annular input hydraulic cavity therebetween.

7. The kit according to claim 6, wherein said piston has an associated piston cavity for developing a pressure head for driving said piston, and said input hub has a conduit interconnecting said piston cavity and said annular input hydraulic cavity.

8. The kit according to claim 7, wherein said rotary union further comprises a pair of anti-friction bearings.

9. The kit according to claim 6, wherein said first gland ring is of a larger diameter than said second gland ring, proving a hydraulic piston effect on said collar, thereby loading at least one of said pair of anti-friction bearings.

10. The kit according to claim 9, wherein said anti-friction bearings are tapered roller type bearings.

11. The kit according to claim 10, wherein said anti-friction bearings are spring biased.

12. The kit according to claim 11, wherein said rotary union comprises seals interposed between said input hub and said collar at opposite ends of said collar, and further comprising a hydraulic drain between said pair of anti-friction bearings and one of said seals.

13. The kit according to claim 12, further comprising inlet and outlet hydraulic hoses adapted for interconnection with a housing plate cover of the clutch.

14. The kit according to claim 1, wherein said drive flange comports to SAE J620 for interconnection with a flywheel.

15. A hydraulic power take-off clutch, comprising:
a housing defining an envelope, said envelope conforming to the envelope of a housing configured according to SAE J621d, said envelope receiving:
an input hub securedly received upon a shaft;
an end plate secured to said input hub;
a drive flange adapted for securement to a flywheel of a power source;
a hydraulically actuated clutch disk assembly received upon a first end of said input hub and in interconnection with said drive flange; and
a rotary union received upon an opposite second end of said input hub.

16. The hydraulic power take-off clutch according to claim 15, wherein said hydraulically actuated clutch disk assembly comprises multiple disks operatively connected to said drive flange and multiple separator disks, interleaved with said friction disks, operatively connected to said input hub and a piston axially movably received upon said input hub.

17. The hydraulic power take-off clutch according to claim 16, wherein said input hub and shaft are an integral unit.

18. The hydraulic power take-off clutch according to claim 16, wherein said rotary union comprises a collar received upon said input hub and first and second gland rings interposed between said collar and said input hub and defining an annular input hydraulic cavity therebetween.

19. The hydraulic power take-off clutch according to claim 18, wherein said piston has an associated piston cavity for developing a pressure head for driving said piston, said input hub has a conduit interconnecting said piston cavity and said annular input hydraulic cavity, and said rotary union further comprises a pair of anti-friction bearings.

20. The hydraulic power take-off clutch according to claim 19, wherein said first gland ring is of a larger diameter than said second gland ring, providing a hydraulic piston effect on said collar, thereby loading at least one of said pair of anti-friction bearings.
